(19) United States
(12) Patent Application Publication
(10) Pub. No.: US 2016/0375700 A1
(43) Pub. Date: Dec. 29, 2016

(54) Portable Image Printing Device

(71) Applicant: Charles Moncavage, Nazareth, PA (US)

(72) Inventor: Charles Moncavage, Nazareth, PA (US)

(21) Appl. No.: 15/178,748

(22) Filed: Jun. 10, 2016

Related U.S. Application Data
(60) Provisional application No. 62/174,722, filed on Jun. 12, 2015.

(51) Int. Cl. B41J 3/407; H04N 1/00

(52) U.S. Cl. CPC B41J 3/407; H04N 1/00885; H04N 1/00559

(57) ABSTRACT

In described embodiments, a portable image printing device is disclosed. The device is self-propelled and rolls over a substrate onto which the device imparts an image. The image is drawn from an electronic image file retained within or otherwise supplied to the device. The device can use a plurality of media, such as, for example, chalk or paint that is dispensed vertically onto the substrate. Alternatively, a cutting head can be used to cut an image into a grass-filled substrate.

### CROSS-REFERENCE TO RELATED APPLICATION

The present application claims priority from U.S. Provisional Patent application 62/174,722, filed on Jun. 12, 2015, which is incorporated herein by reference in its entirety.

### BACKGROUND OF THE INVENTION

Field of the Invention

This invention relates to the field of image printing onto a substrate. More specifically, the invention provides a means for applying an image to a stationary and unmovable substrate such as paved ground, grass covered ground or similarly fixed surfaces.

Description of the Related Art

Many types of image printing devices exist that include a computer controlled printer whereby a movable substrate, normally paper, is fed through an arrangement of paper handling rollers into proximity with an effector that transfers ink to the substrate to apply a predetermined image to the substrate. Other types of printing machines consist of a table or platen onto which the substrate is fixed while an effector is moved about the perimeter of the printing area while ink is dispensed onto the fixed substrate. In this case the effector is moved about the substrate by a CNC Cartesian robot that straddles over the substrate platen. These examples, among others, are useful in the case where the substrate is able to be moved and fixed to the printing area of the machine and where the substrate is of a size that corresponds with the dimensional capabilities of the printing machine. If the substrate is not able to be moved to the printing machine or is larger than the capabilities of the machine, the image may not be able to be transferred onto that substrate or it may be printed by manual methods like stenciling or freehand drawing.

It would be beneficial to provide an image printing device that can print on a substrate that is larger than the print area of the printing machine.

### SUMMARY OF THE PRESENT INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

To address the shortcomings of the current technologies, the present invention provides a means for printing an image onto a large as well as permanently fixed substrate. More specifically, the device is a portable Cartesian robot gantry having a moveable x and y axis and a vertical axis whereby a printing effector, dispenser or other imaging apparatus will distribute a print medium that can be a variety of paint, ink or pigmented liquids or solid material, such as chalk or chalk dust, onto a fixed substrate to form a predetermined image onto the substrate.

The invention also provides an alternative to the dispensing of pigmented liquids by adapting a commercially available chalk stick or other drawing implement to its perpendicular axis and moving the effector about the fixed substrate to draw the image onto the substrate.

As another alternative to liquid dispensing, the effector may carry a powder such as chalk or dehydrated paint about the fixed surface while dispensing or dropping the powder onto the fixed surface to form as image on the surface.

An inventive aspect of the invention is that one of the horizontal axis is movable over the surface of the substrate while the axis remains in full contact with said surface during the printing process. The first axis may be movable over the surface by means of wheels, track belt while the second axis is perpendicularly attached to the first axis and allowed to move in coordinated motion with each other as in a CNC automated process.

Another aspect of the invention is that the invention may be programmed to draw an outline that allows for subsequent filling of the blank areas of the printed image such as in the example of a coloring book image that may be printed onto a paved surface to be “colored” by a child as one would in the case of a coloring book. The inventive device is also capable of dispensing a pigmented material onto a course or non-uniform surface such as grass on a sports playing field or golf course. The machine may be used to apply a mascot image to a grass or other type of field or sponsor logos and other images to a golfing surface.

In any of the mentioned uses, it may be desired that the images are easily removed when the image is no longer wanted on the surface. In this case, the print medium can be a washable material and readily washed away.

Another novel aspect of the invention is that the above mentioned effector may be a cutting or trimming device such as a string type weed trimmer that is moved about the image area of a grass surface while trimming the grass to a second height as compared to the grass surface resulting in a three dimensional predetermined image on the surface.

Another aspect of the invention is that the device is capable of having a variety of the mentioned effectors available and readily interchangeable.

While the first mentioned axis is in constant contact with the surface of the substrate and has wheels or tracks that give the axis the ability to move infinitely in a line with that axis, the second axis being fixed to the first axis limits the range by the length of the second axis beam. To overcome this shortcoming, the device may include provisions for readily exchanging the beam of the second axis with a beam of a suitable length.

The first axis wheels or belt may be operated independently so that the device may be navigated remotely by the operator without removing the device from contact with the surface. By controlling the speed, proportion and direction of the first axis carriage wheels or belts in relation to the opposing wheels or tracks of the same axis, an operator may guide the device over the substrate as with a typical remote control toy vehicle and into a position on the surface where the user wishes to apply an image. In addition, the independent wheel movement allows the operator to print an image onto a substrate while maneuvering the device manually via remote control causing the image to print in an arched or wavy effect. Likewise, the operator may print an arched text or other image by varying the rotation ratio of one carriage wheel assembly relative to the other carriage wheel assembly to produce an arched text effect.

### BRIEF DESCRIPTION OF THE FIGURES

Other aspects, features, and advantages of the present invention will become more fully apparent from the following detailed description, the appended claims, and the accompanying drawings in which like reference numerals identify similar or identical elements.

FIG. 1 is a perspective view of a portable image printing device (“printing device”) according to a first exemplary embodiment of the present invention;

FIG. 2 is a perspective view of a roller assembly of the printing device shown in FIG. 1;

FIG. 3 is a schematic view of the top of the printing device shown in FIG. 1;

FIG. 4 is a side elevational view of the printing device shown in FIG. 1, with the front of the beam removed;

FIG. 5 is a front perspective view of the left hand portion of the printing device shown in FIG. 1;

FIG. 6 is a sectional view of a mounting plate slidably mounted on the rails on the front of the beam of the printing device shown in FIG. 1;

FIG. 7 is a top perspective view of the mounting plate shown in FIG. 6;

FIG. 8 is a perspective view of the mounting plate shown in FIG. 6, showing how the effector shown in FIG. 1 is attached thereto;

FIG. 9 is a perspective view showing the effector attached to the mounting plate shown FIG. 8;

FIG. 10 A bottom elevational view of the printing device shown FIG. 1

FIG. 11 is an exemplary electrical schematic for the printing device shown in FIG. 1;

FIG. 12 is a perspective view of the central portion of the top of the printing device shown FIG. 1 showing the handle and controller;

FIG. 13 is a schematic view of a printing device according to a second exemplary embodiment of the present invention;

FIG. 14 is a perspective view of a printing device according to a third exemplary embodiment of the present invention with a beam having a first length;

FIG. 15 is a perspective view of the printing device shown in FIG. 14, with the beam having a second length;

FIG. 16 is a perspective view of a printing device according to an alternative exemplary embodiment of the present invention;

FIG. 17 is an exploded view of the printing device shown in FIG. 16;

FIG. 18 is an exploded view of an exemplary drive mechanism used with the printing device shown in FIG. 16;

FIG. 19 is a perspective view of an exemplary beam and carriage used with the printing device shown in FIG. 16;

FIG. 20 is a bottom perspective view of the beam and carriage assembly shown in FIG. 19;

FIG. 21A is a side elevational view of a paint can mounted in a first position on the beam and carriage assembly shown in FIG. 19;

FIG. 21B is a side elevational view of a paint can mounted in a second position on the beam and carriage assembly shown in FIG. 19;

FIG. 21C is a side elevational view of a paint can mounted in a third position on the beam and carriage assembly shown in FIG. 19;

FIG. 22A is a side elevational view of a cam in a non-activating position on the device shown in FIG. 16;

FIG. 22B is a side elevational view of a cam in a first activating position on the device shown in FIG. 16; and

FIG. 22C is a side elevational view of a cam in a second activating position on the device shown in FIG. 16.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. As used herein, the term “longitudinal” is defined as a straight-line direction of the travel of the inventive printing device and the term “lateral” is defined as a straight-line direction perpendicular to the longitudinal direction, or straight-line direction between roller assemblies of the inventive printing device. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

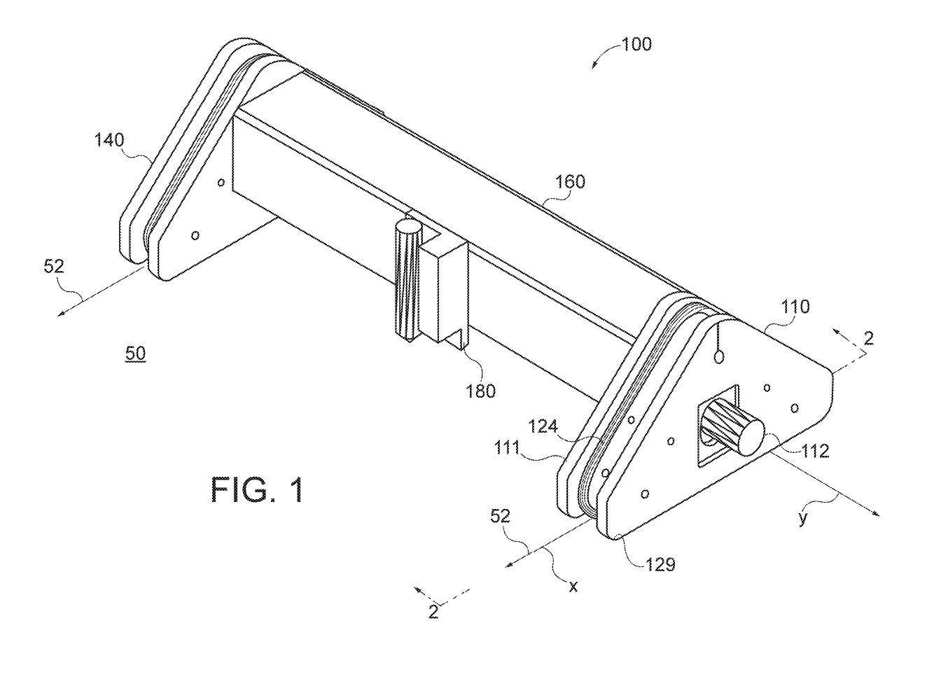

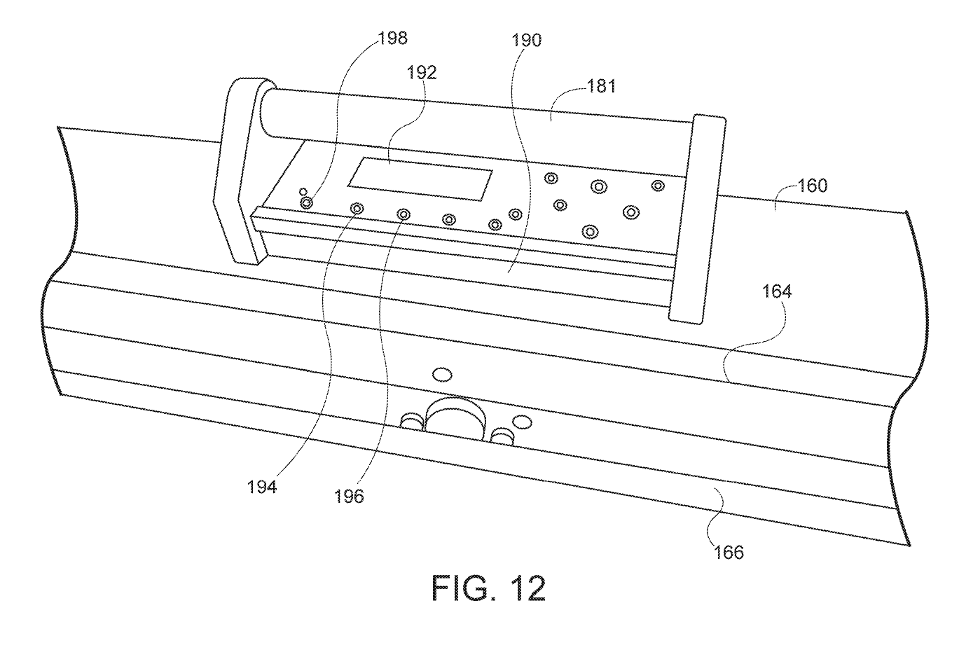

Referring now to FIGS. 1-12, a portable image printing device 100 (“printing device”) according to a first exemplary embodiment of the present invention is shown. Printing device 100 rolls freely on top of a fixed substrate 50, such as, for example, blacktop, concrete, grass, or other generally flat substrate, represented by the plane of the paper of FIG. 1. Substrate 50 is larger than the largest dimension of printing device 100 such that device 100 rolls on top of and over substrate 50 while printing device 100 is discharging a printing material onto substrate 50.

While it is desired the substrate 50 be generally flat, substrate 50 can have imperfections such that at least one part of substrate 50 may be vertically higher than another part of substrate 50. Also, while it is desired substrate 50 is generally flat or horizontal, those skilled in the art will recognize that substrate 50 can be disposed at an angle relative to the horizontal, although such angle must be of a degree to allow printing device 100 to traverse substrate 50 without slippage.

Printing device 100 travels in a longitudinal, or “x”, direction as indicated by arrows 52 shown in FIG. 1. Printing device 100 includes a first roller assembly 110, a second roller assembly 140, and a connecting beam 160 extending between first roller assembly 110 and second roller assembly 130. Connecting beam 160 also includes an effector 180 that laterally traverses printing device 100 between first roller assembly 110 and second roller assembly 140. In a first embodiment, as shown in FIG. 1, effector 180 is a paint sprayer that sprays a stream of paint or other liquid onto substrate 50. In an alternative embodiment, effector 180 can be a printhead that dispenses ground particles, such as, for example, chalk dust, onto substrate 50.

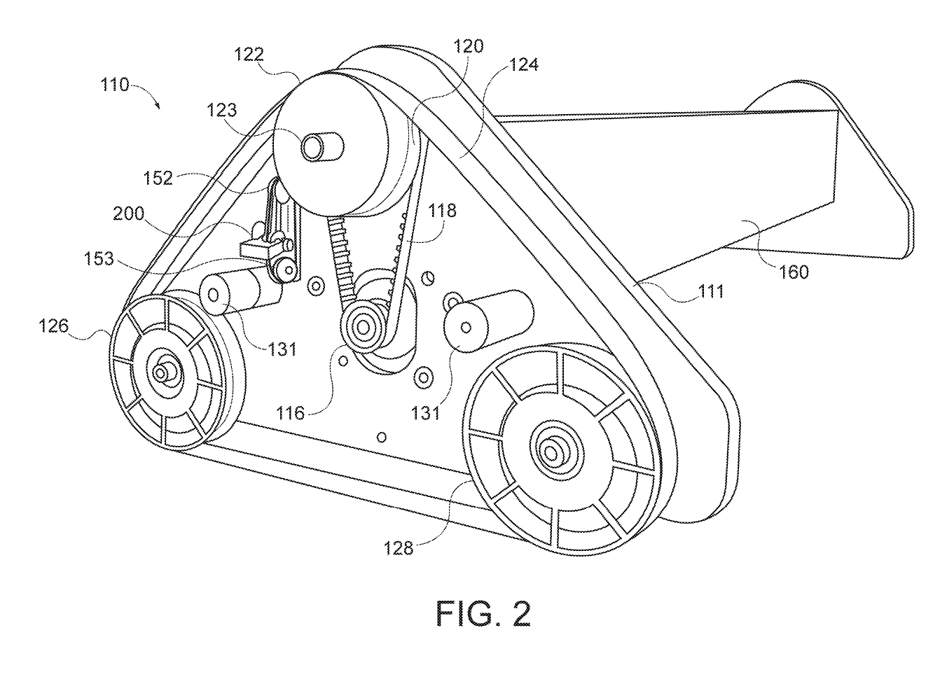

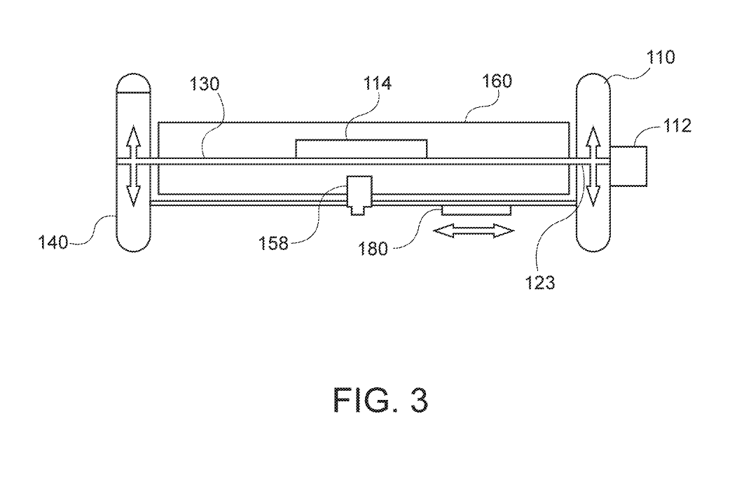

FIG. 2 is a sectional view of first roller assembly 110. Roller assembly 110 includes a frame 111 that supports a drive motor 112 (shown in FIG. 1). Drive motor 112 is electrically powered by a power source 114 (shown in FIG. 3) located within beam 160. While an exemplary embodiment, a power source 114 can be a battery, those skilled in the art will recognize that other types of power sources, such as, for example, a solar cell mounted on top of beam 160, can be used.

A first drive wheel 116 is operatively connected to the output of drive motor 112. A first drive belt 118 extends partially around first drive wheel 116 and is driven by drive wheel 116. First drive belt 118 also extends partially around a second drive wheel 120 that is rotatably mounted onto frame 111 such that rotation of first drive wheel 116 rotates first drive belt 118, which in turn rotates second drive wheel 120. Second drive wheel 120 is coaxially connected to an upper wheel 122 via a connecting shaft 123 such that upper wheel 122 rotates with second drive wheel 120. A second drive belt 124 extends partially around upper wheel 122, as well as two lower wheels 126, 128 that are also rotatably mounted to frame 111 such that rotation of upper wheel 122 rotates second drive belt, which, in turn, rotates lower wheels 126, 128. Wheels 126, 128 propel device 100 across substrate 50. A front cover plate 129 is attached to frame 111 and protects drive motor 112, drive belts 118, 124, and wheels 116, 120, 126, 128. As shown in FIG. 2, spacers 131 can be provided to space front cover plate 129 from frame 111.

Referring to FIG. 3, a shaft 130 extends co-axially with connecting shaft 123 and extends through connecting beam 160 to drive second roller assembly 140. Second roller assembly 140 is identical to first roller assembly 110, with the exception of drive motor 112, which is omitted from second roller assembly 140. Wheels 126, 128 of second roller assembly 140 rotate in conjunction with wheels 126, 128 of first roller assembly 110 to propel device 100 along the x-axis 52, as shown in FIG. 1. Wheels 126, 128 can be reversed such that device 100 can be propelled along the negative of x-axis 52.

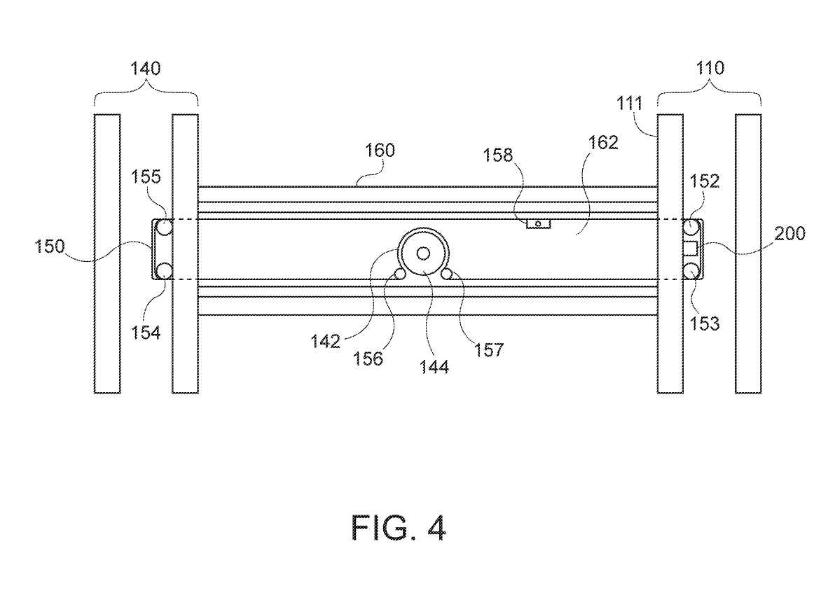

Referring now to FIG. 4, a carriage motor 142 is mounted inside beam 160 and has an output drive wheel 144 that extends outwardly from a front face 162 of beam 160. Operation of motor 142 rotates drive wheel 144 in a plane generally parallel to the front face 162 of beam 160. Drive wheel 144 rotates an endless loop belt 150 that extends around idler wheels 152-157. In an exemplary embodiment, belt 150 can be a strand of inextensible material, such as, for example, Kevlar. Alternatively, those skilled in the art will recognize that other types of belts, such as, for example, a chain, a timing belt, or other suitable endless loop belt, may be used.

Idler wheels 152, 153 are mounted in first roller assembly 110 and idler wheels 154, 155 are mounted in second roller assembly 130. Idler wheels 156, 157 are mounted on front face 162 of beam 160 generally below drive wheel 146 such that, as belt 150 winds around drive wheel 146 and idler wheels 152-157, belt 150 engages drive wheel 146 over an arc of about 270 degrees around the outer perimeter of drive wheel 146. A plate connector 158 is fixedly attached to belt 150. A mounting plate 168 that is used to mount effector 180, thereon is attachable to play connector 158.

A tensioning device 200 is shown in FIGS. 2 and 4. Tensioning device 200 can be used to tighten belt 150. Tensioning device 200 is located between idler wheels 152 and 153 in order to pull belt 150 away from idler wheels 152 and 153 to reduce slack in belt 150.

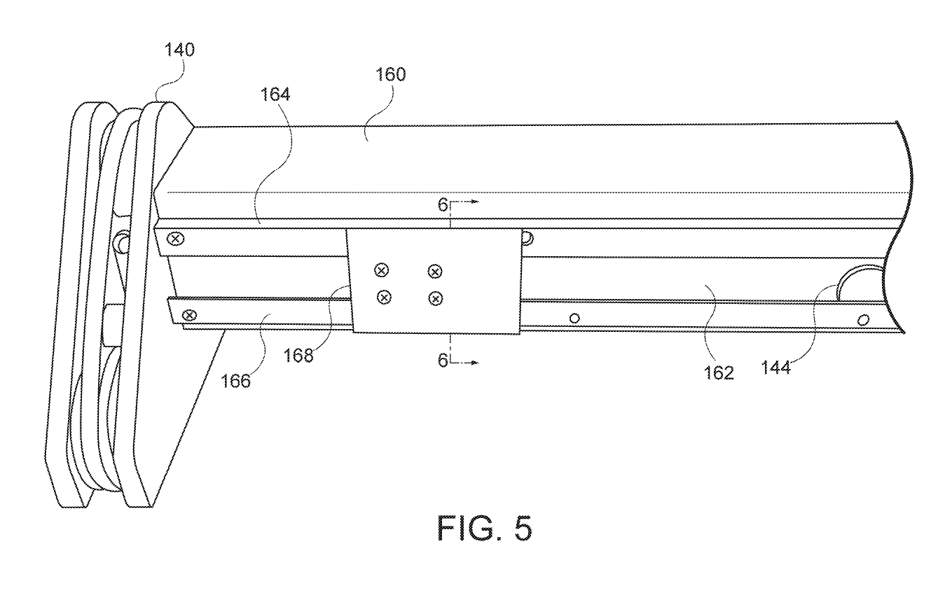

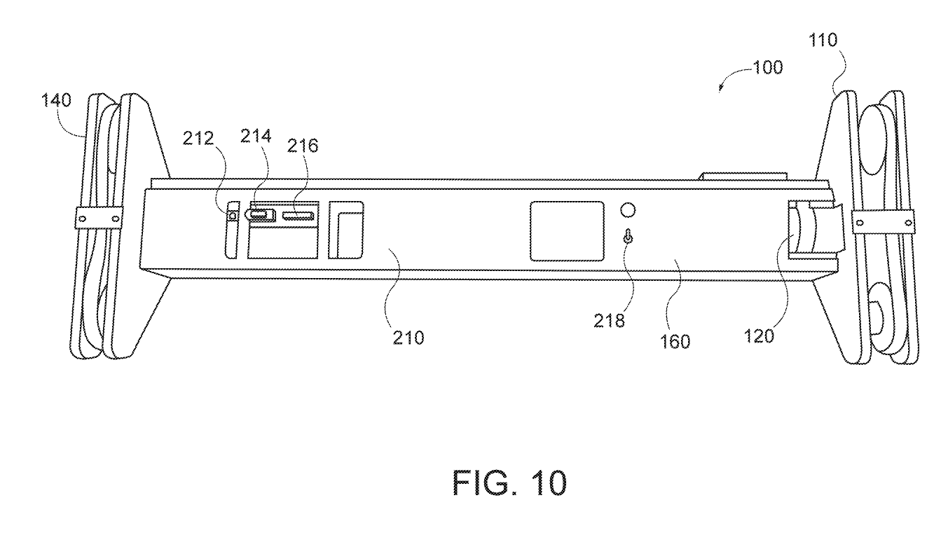

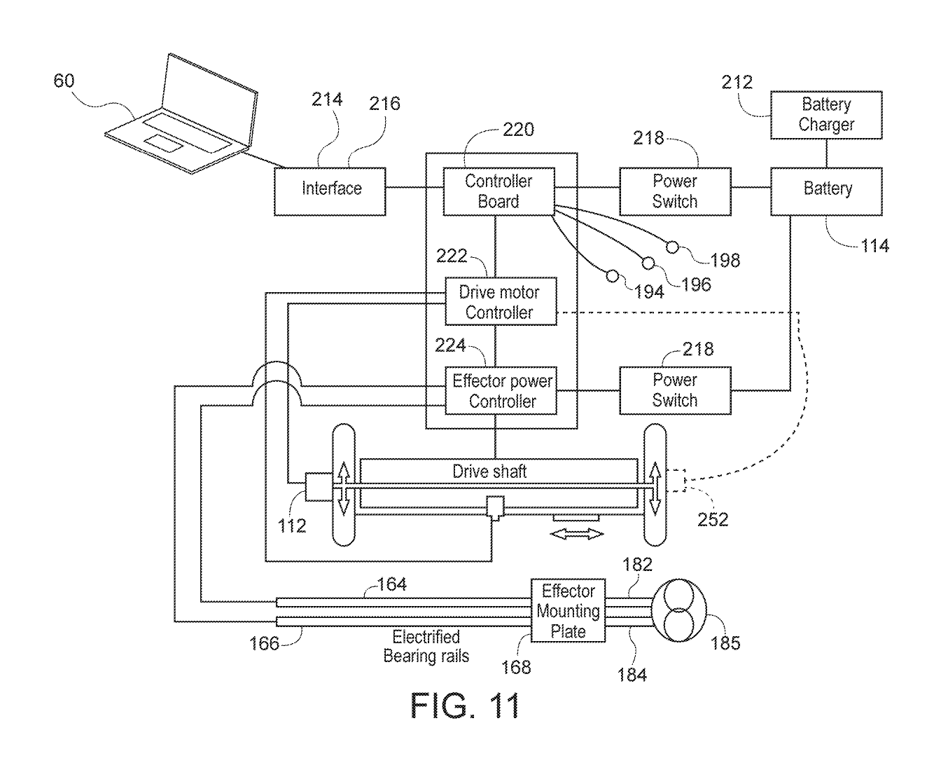

Referring now to FIG. 5, an upper rail 164 and a lower rail 166 are mounted on front face 162 of beam 160 such that drive wheel 144 is between lower rail 166 and front face 162 of beam 160. Each of upper rail 164 and lower rail 166 are electrified with electricity from power source 114 (shown FIGS. 3 and 11) to provide electrical power to a pump 185 (shown schematically in FIG. 11) on effector 180 from power source 114. An exemplary electrical schematic for printing device 100, shown in FIG. 11, shows the electrical circuit used to power effector 180.

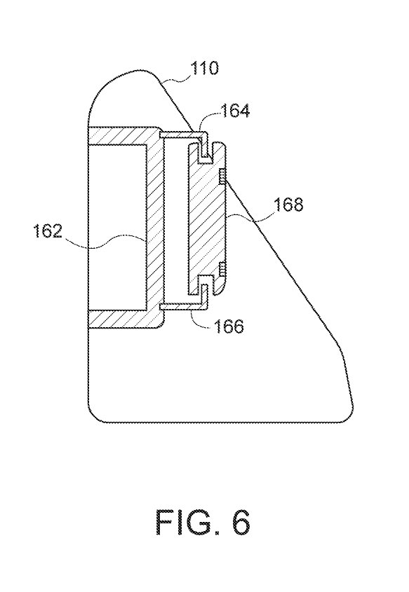

Plate connector 158 extends below upper rail 164. As shown in FIG. 6, a gap is formed between front face 162 and the front of each of rails 164, 166 such that mounting plate 168 having a generally “H” shaped cross-section fits between rails 164, 166. Mounting plate 168 is attached to plate connector 158 such that, when drive wheel 146 drives belt 150 and plate connector 158, mounting plate 168 traverses the length of beam 160. Mounting plate 168 is constructed from an electrically insulating material such as, for example, a polymer. Optionally, although not shown, rollers can be attached to the top and bottom of mounting plate 168 to facilitate sliding of mounting plate 168, between rails 164, 166. Those skilled in the art will recognize that other types of mounting connections to reduce friction between mounting plate 168 and rails 164, 166 can be used instead.

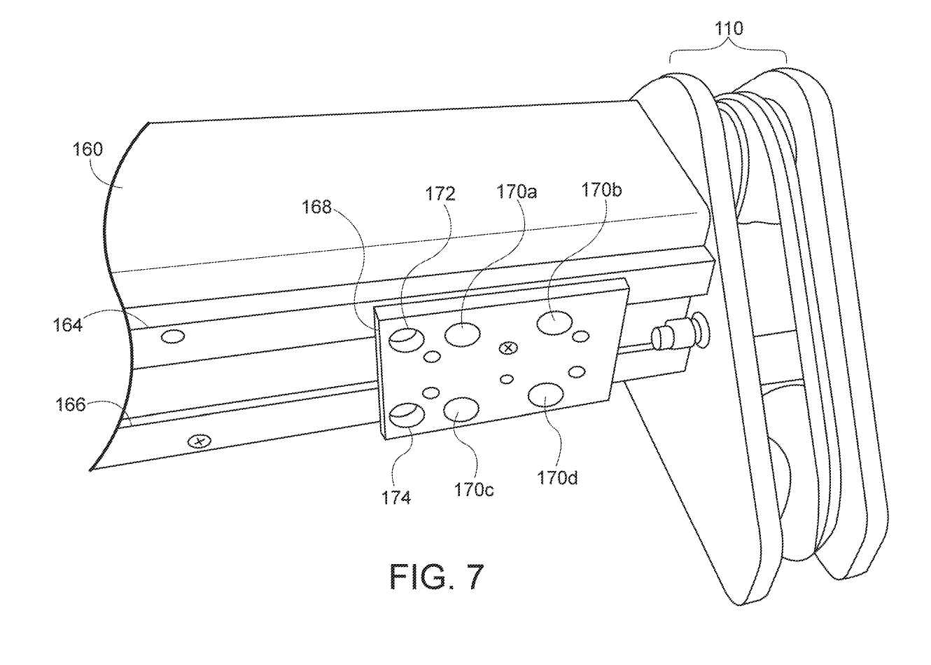

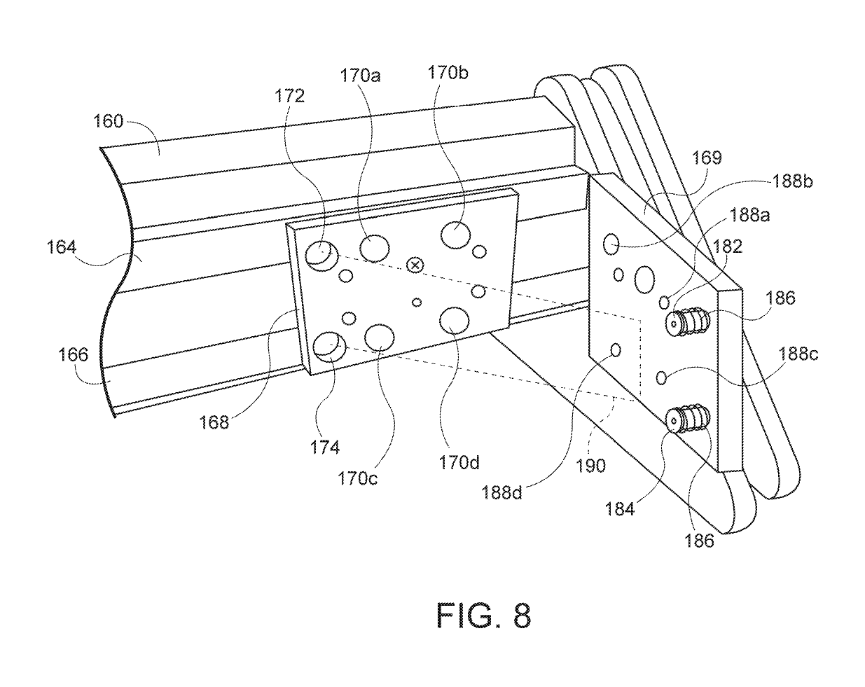

FIGS. 7 and 8 show front views of mounting plate 168. Mounting plate 168 includes a plurality of magnets 170a-d that mate with magnetically attractive surfaces 188a-d, respectively, on a non-electrically conducting mounting plate 169 four effector 180 to releasably secure effector 180 onto mounting plate 168. Mounting plate 168 also includes a plurality of through openings 172, 174 through which Pogo pins 182, 184 extend to electrically engage rails 164, 166, respectively. Each Pogo pin 182, 184 includes a biasing member, such as, for example, a spring 186 that biases the head of each Pogo pin 182, 184 against its respective rail 164, 166 to ensure electrical contact between rails 164, 166 and their respective Pogo pins 182, 184. Pogo pins 182, 184 are electrically connected to effector 180, shown in FIG. 11, to transmit electrical power from rails 164, 166 to effector 180. Dashed lines 190 in FIG. 8 show how Pogo pins 182, 184 are inserted through openings 172, 174, respectively.

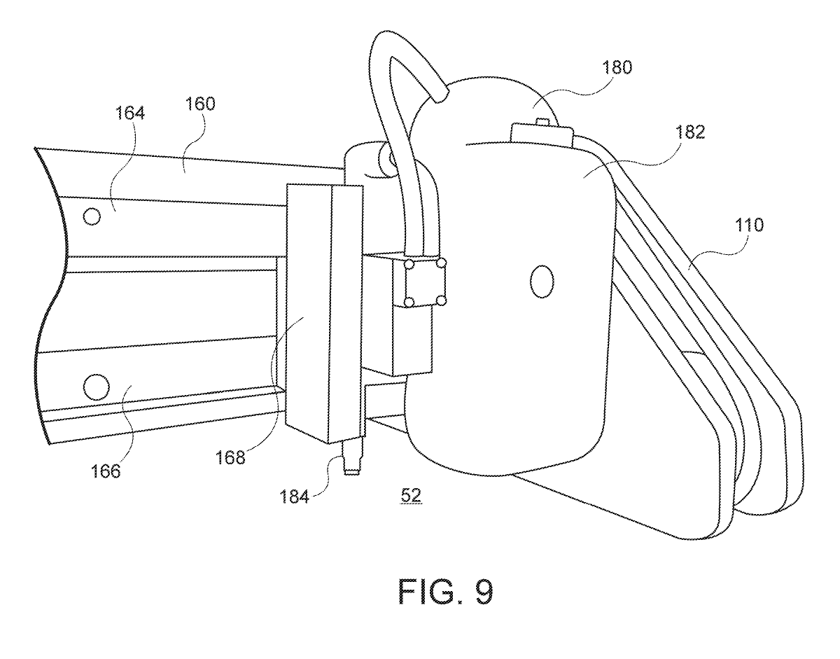

An exemplary effector 180 mounted on mounting plate 168 is shown FIG. 9. In this embodiment, effector 180 may include a commercially available liquid reservoir 182 operatively connected to a dispenser nozzle 184 for dispensing liquid within liquid reservoir 182 onto substrate 50, such as, for example, to draw a picture. While effector 180 is shown in FIG. 9 as a liquid dispenser, those skilled in the art will recognize that effector 180 can be other units, such as, for example, a solid (granular or powder) dispenser, a drawing stick (chalk stick) that physically engages substrate 50, a rotating filament (Weed Wacker) or other electrically operated unit that can leave a mark on or otherwise modify substrate 50. Further, while reservoir 182 is a single reservoir for containing a single color liquid, those skilled in the art will recognize that, alternatively, multiple reservoirs (not shown), with different colored liquids can be incorporated into effector 180.

An underside portion 210 of beam 160 is shown in FIG. 10. Hardwire electrical connections, such as, for example, a USB port 212, a serial RS-232 port 214 and a parallel port 216 are shown. USB port 212 can be used to recharge power source 114 while hardwire connections to 14, 16, such as, for example, RS-232 port 214 and/or parallel port 216, can be used to provide electronic information to controller 183 for controlling the operation of effector 180. While removable hardwire connections 214, 216 for transmitting an image file to bring device 100 are shown, those skilled in the art will recognize that wireless connections to a controller 220 (shown in FIG. 11) from an outside source, such as a remote device 60 (also shown in FIG. 11), can be provided instead.

Additionally, a power switch 218 to provide electrical power from power source 114 can be provided on beam 160. Power switch 218 can be electrically coupled to control board 220 and/or effector power controller 224 While FIG. 10 shows hardwire connections 214, 216 and power switch 218 on the underside portion 210 of beam 160, those skilled in the art will recognize that hardwire connections 214, 216 and power switch 218 can be located other places on device 100. While, in FIG. 1, drive motor 112 that is used to power roller assemblies 110, 140 is shown as extending outwardly from 110, alternatively, as shown in FIG. 10, drive motor 112 can alternatively be mounted within beam 160.

An exemplary electrical schematic drawing for device 100 is shown in FIG. 11. As shown in the Figure, a remote device 60, such as, for example, a laptop computer 60, can be provided to generate an image that will be printed by printing device 100. A file containing the image is transmitted from remote device 60, via connections 214, 216, or wirelessly to controller 220. Printing device 100 may be configured to a print raster type image onto substrate 50. In such an arrangement, effector 180 will traverse (in a scanning motion) the entire image area of substrate 50 while placing dots of the printing material (paint) onto the locations that need to be covered by the material to form the image. After each pass over the length of beam 160, drive motor 112 will advance printing device 100 a predetermined distance, and effector 180 will then traverse across beam 160 along the opposite direction (parallel to the y-axis). This process is similar to the method commonly used in a desktop printer, such as an inkjet or a laserjet printer.

Alternatively, an alternative exemplary embodiment of printing device 100 may be configured to dispense the paint product by drawing lines and arcs from point to point as a person would commonly do while drawing the image with pencil or other handheld implement in a process known as a vector type drawing. In this embodiment, drive motor 112 can be moving printing device 100 along the X-axis while, simultaneously, effector 180 is traversing along the length of beam 160 and discharging printing medium onto substrate 50.

The control system for printing device 100 also includes a drive motor controller 222 that receives electronic signals from controller 220. Controller 222 is operatively connected to drive motor 112 as well as to carriage motor 142. Additionally, drive motor controller 222 is also electronically connected to an effector power controller 224 that provides electrical power to effector 180 via rails 164, 166. The electricity from rails 164, 166 is used to power pump 185 on effector to dispense the printing material onto substrate 50.

In an exemplary embodiment, as illustrated in FIG. 3, power source 114 is generally centrally located within beam 160, generally underneath handle 230, in order to centrally balance the weight of power source 114 within beam 160. Additionally, an operator control interface 190 is located beneath handle 181 and is operatively coupled to controller 220. Operator control interface 190 includes a display panel 192 that displays operating parameters, such as, for example, the speed of printing device 100. A first button 194 can be pressed to increase the speed of printing device 100 and a second button 196 can be pressed to decrease the speed of printing device 100. In an exemplary embodiment, printing device 100 can be programmed to traverse over substrate 50 at speeds of 4 in./second, 8 in./second, 12 in./second, or 16 in./second, although those skilled in the art will recognize that printing device 100 can be programmed to operate at different speeds as well.

Additionally, a “Clear” button 198 can be pressed to clear the memory in controller 220 so that a new program can be transmitted to controller 220 for printing by printing device 100.

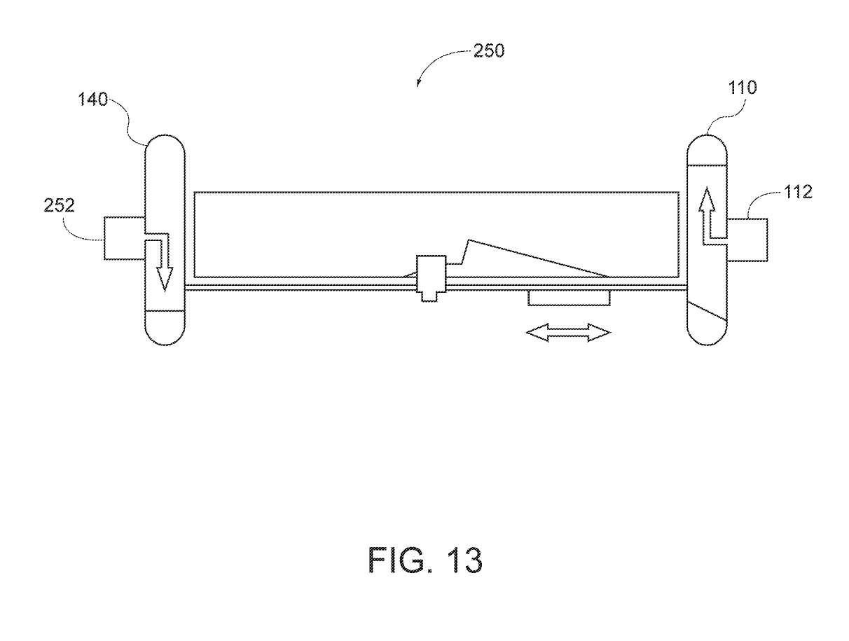

In an alternative exemplary embodiment of a printing device 250, shown in FIG. 13, roller assembly 110 is de-coupled from roller assembly 140 such that roller assembly 140 is independently operable from roller assembly 110. As a result, drive assemblies 110, 140 can be operated by drive motor controller 222 at different speeds, resulting in printing device 250 being able to turn. Still alternatively, drive assemblies 110, 140 can be operated in different directions (roller assembly 140 can be reversed relative to roller assembly 110), resulting in printing device 250 in place. Drive assembly 140 is operated by a separate drive motor 252 that is separately controlled by controller 220, as shown by the dashed lines in FIG. 11.

In the exemplary embodiments described above, connecting beam 160 is fixedly connected to each of first roller assembly 110 and second roller assembly 140.

In an alternative exemplary embodiment of a printing device 300 according to the present invention, however, as shown in FIGS. 14 and 15, a connecting beam 350 is removably connected to each of a first roller assembly 310 and a second roller assembly 330 so that connecting beam 350 can be removed from printing device 300 and replaced with a connecting beam 350′ (shown in FIG. 15), that has a length different than connecting beam 350 to form printing device 300′. The interchangeability of connecting beam 350 and connecting beam 350′ allows printing devices 300, 300′ of different lateral length to be able to print different sized output onto substrate 50.

Optionally, substrate 50 can be coated with a sealant (not shown) after printing with effector 180 in order to retain the image generated onto substrate 50 for extended period of time.

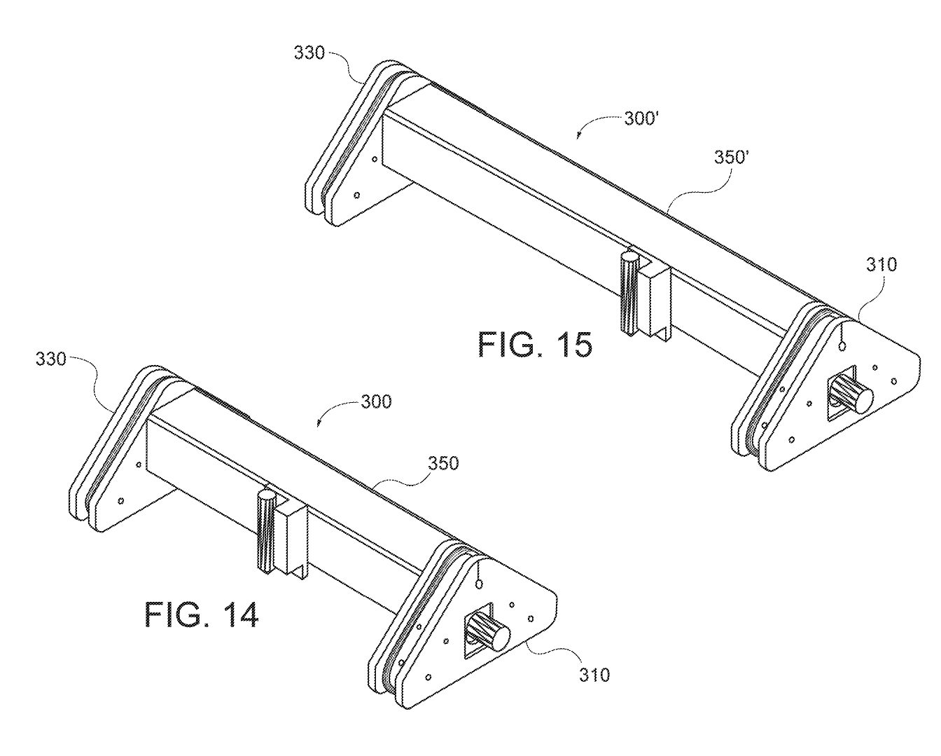

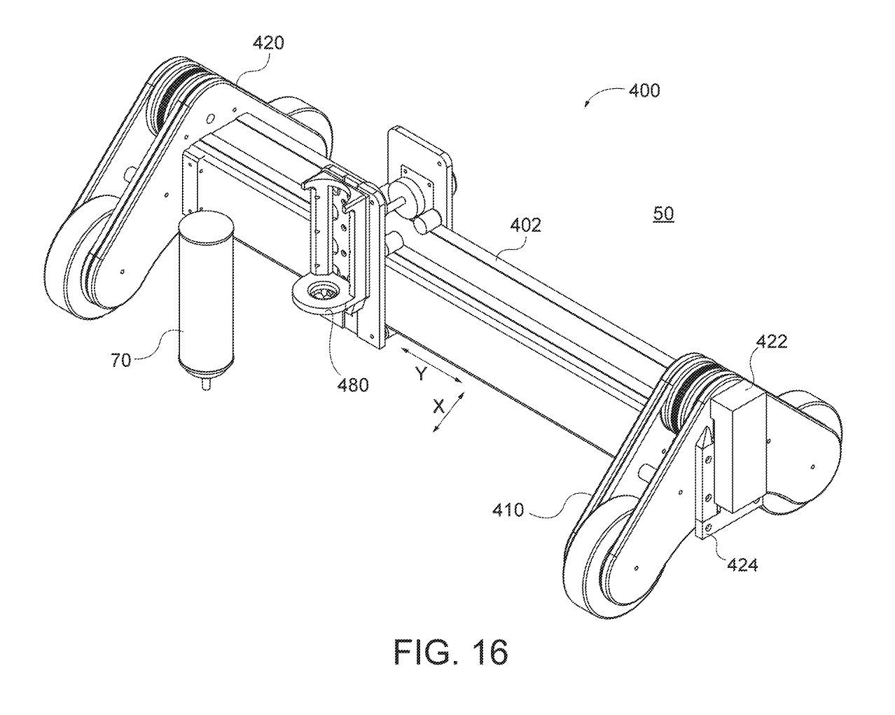

An alternative embodiment of a printing device 400 is shown in FIGS. 16-22C. Device 400 is similar to the previously described embodiments, with alternative features regarding translation and dispensing of a print medium from an effector assembly 480. Device 400 rolls freely on top of a fixed substrate 50, such as, for example, blacktop, concrete, grass, or other generally flat substrate, represented by the plane of the paper of FIG. 16. Substrate 50 is larger than the largest dimension of printing device 400 such that device 400 rolls on top of and over substrate 50 while printing device 400 is discharging a printing material onto substrate 50.

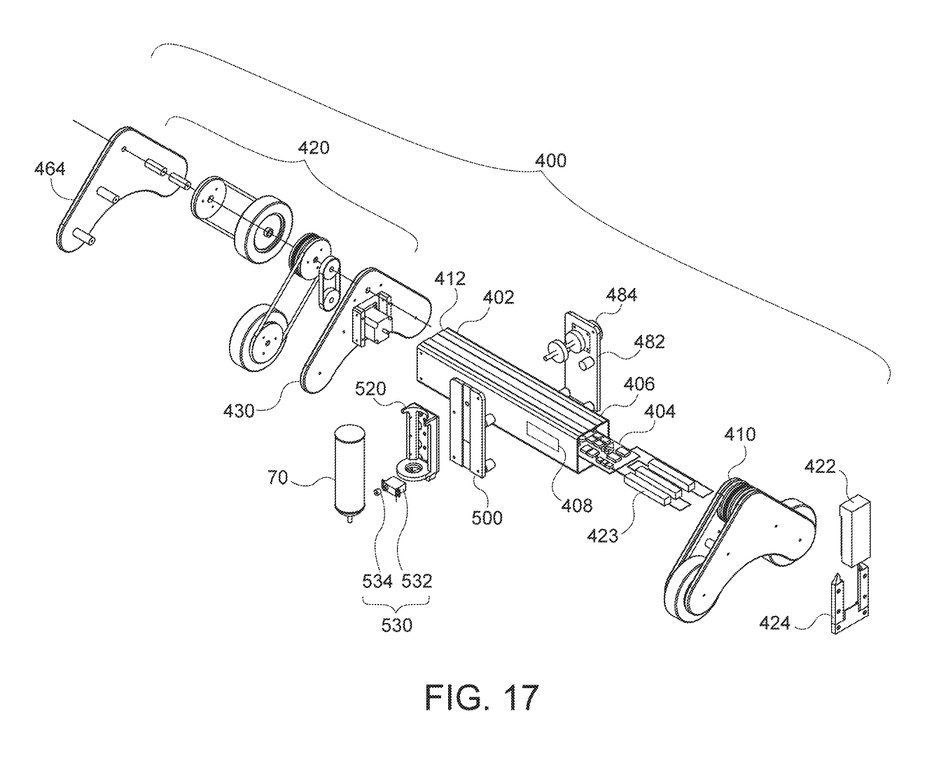

Referring to FIG. 17, device 400 includes a frame in the form of a generally hollow beam 402 on which other elements of device 400 are connected. Beam 402 can be hollow so that some components, such as, for example, a controller 404, can be stored therein. Beam 402 includes a first end 406 to which a first drive assembly 410 is connected, and a second end 412, distal from first end 406, on which a second drive assembly 420 is connected. Each of first and second drive assemblies 410, 420 can be removably connected to beam 402, such as by screws, to allow beam 402 to be replaced by a beam of a different length, or to repair/replace controller 404, if required.

An effector assembly 480 rides on beam 402 between first drive assembly 410 and second drive assembly 420. Effector assembly 480 prints an image onto a substrate 50, such as, for example, asphalt, concrete, grass, or any other surface over which drive assemblies 410, 420 can travel.

Effector assembly 480 cooperates with drive assemblies 410, 420 to print an image onto substrate 50 that is provided through controller 404 in the form of an electronic file, such as, for example, a JPEG, GIF, PDF, raster, or other type of electronic image. Referring specifically to FIG. 16, drive assemblies 410, 420 drive device 400 in a direction identified by double arrows X, while effector assembly 480 travels in a direction identified by double arrow Y and discharges a print matter (paint, chalk, etc.) onto substrate 50. The image can be downloaded to controller 404 via a wireless connection or a hardwired connection, such as via a USB or other type of connection 408 located on device 400. While USB port 408 is shown in FIG. 17 as being located on beam 402, those skilled in the art will recognize that USB port 408 can be located in other places on device 400.

Referring to FIG. 17, a power supply 422, such as a rechargeable battery, is releasably attached to first drive assembly 410 via a generally U-shaped retainer 424. Power supply 422 can be recharged while attached to retainer 424 or, alternatively, power supply 422 can be removed from retainer 424 and recharged at a separate location. Power supply 422 provides electrical power to operate first and second drive assemblies 410, 420, effector assembly 480 and controller 404 via electrical connections (not shown).

Instead of, or in addition to, power supply 422 mounted on first drive assembly 410, a power supply 423 can be located inside beam 402. Power supply can be rechargeable via USB port 408.

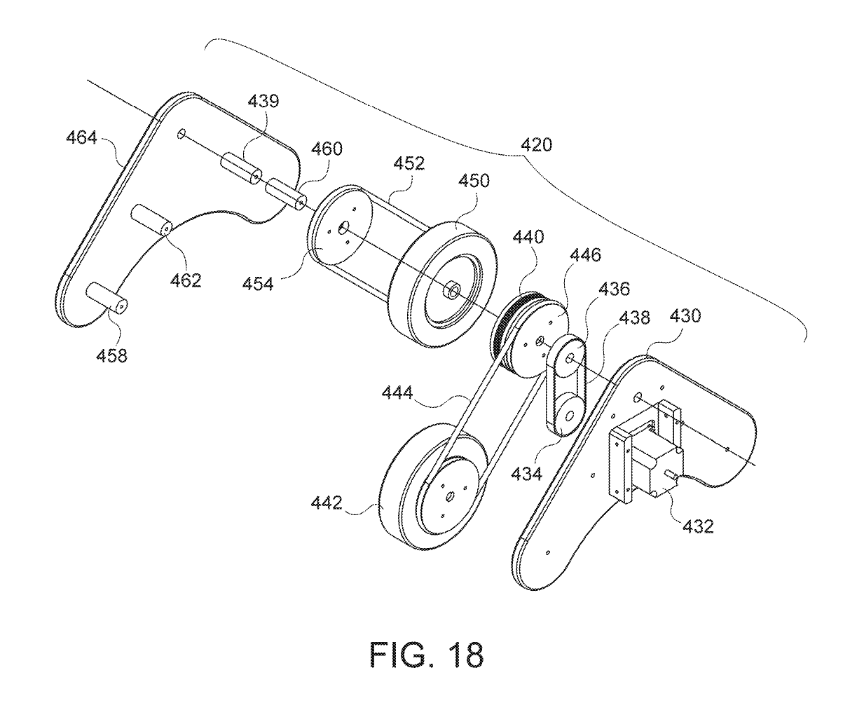

FIG. 18 shows drive assembly 420. Drive assembly 410 is a mirror image of drive assembly 410 with the addition of power supply 422 and retainer 424, although those skilled in the art will recognize that and additional power supply (not shown) can be attached to drive assembly 420 to provide additional power and/or longer operating life.

Drive assembly 420 includes an inner frame 430 and an electric motor 432 attached to inner frame 430. Motor 432 is electrically connected to and driven by power supply 422 through controller 404. An output of motor 432 is connected to and drives a first idler wheel 434. Idler wheel 434 is operatively connected to a drive wheel 436 via a belt 438. Drive wheel 436 rotates on a support shaft 439 and is connected to a wheel driver 440 such that rotation of drive wheel 436 rotates wheel driver 440.

Wheel driver 440 is operatively connected to a first drive wheel 442 via a first drive belt 444 connected to a first pinion 446, and wheel driver is also operatively connected to a second drive wheel 450 via a second drive belt 452 connected to a second pinion 454. Pinions 446, 454 are connected to wheel driver 440 such that pinions 446, 454 and wheel driver 440 all rotate together.

First wheel drive 442 is rotatably supported on a shaft 458 and second wheel drive 450 is supported on a shaft 460. In addition to supporting their respective wheels, shafts 439, 458, 460, as well as a spacer 464, act as spacers to space inner frame 430 from an outer frame 464.

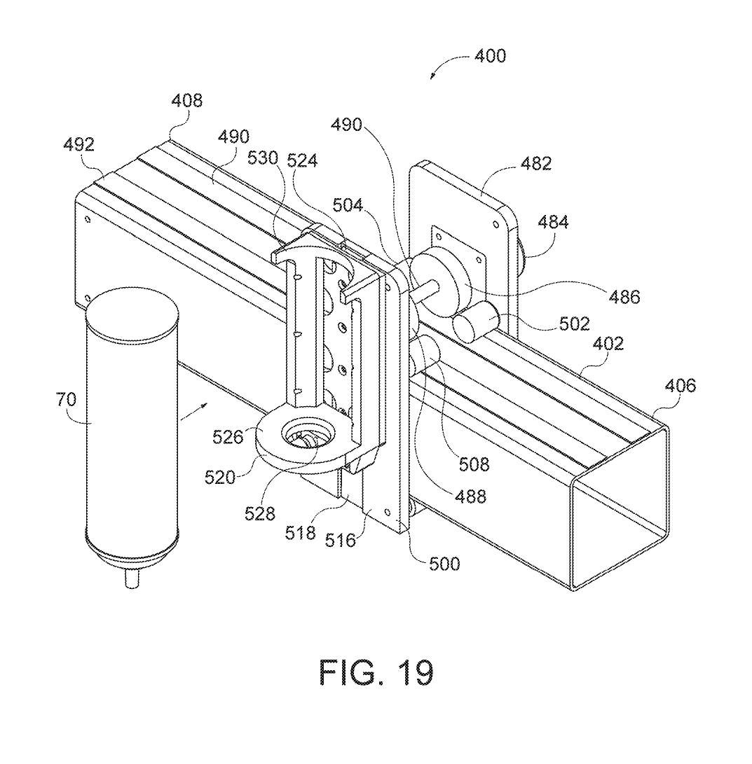

Referring now to FIG. 19, effector assembly 480 includes a first frame mount 482 with a drive motor 484 mounted on an outer portion of frame mount 482. Drive motor 484 is electrically connected to power supply 422 through controller 404 and drives an output wheel assembly 484 that rides along the top surface of beam 402. Output wheel assembly 484 includes a first wheel 486 and a second wheel 488, connected to each other by a shaft 490. Each wheel 486, 488 rides on a respective track 490, 494 mounted on the top of beam 402. Although not shown, each track can be a toothed track and each wheel 486, 488 can have corresponding teeth that engage the teeth on tracks 490, 492 to prevent slippage of wheels 486, 488 with respect to tracks 490, 492.

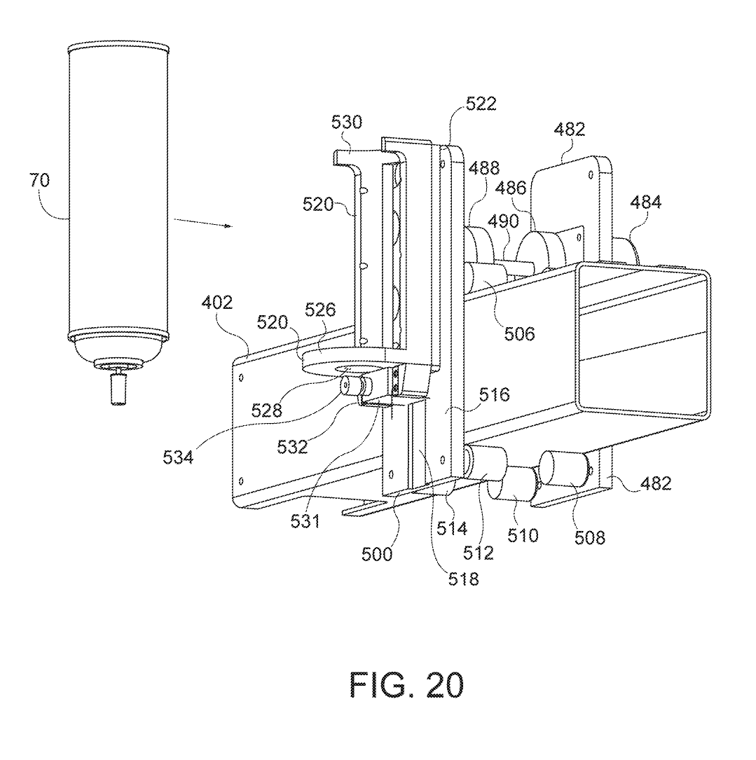

Wheel 488 is rotatably connected to a second frame mount 500 that is used to receive and retain an effector, such as a spray paint can 70. Each of first frame mount 482 and second frame mount 500 includes a pair of upper rollers 502, 504, 506 (second upper roller on second frame mount 500 not shown) and, as shown in FIG. 20, a pair of lower rollers 508, 510, 512, 514. Upper rollers 502-506 and lower rollers 508-514 are used to secure effector assembly 480 onto beam 402 and stabilize effector assembly 480 as effector assembly rolls along the top of beam 402.

Second frame mount 500 includes a generally flat face 516 with a vertical slot 518 extending the length thereof. An effector receiver 520 includes a corresponding flat face 522 that engages flat face 516 of second frame mount 500. Receiver 520 also includes a rib 524 that engages slot 518. At least one of face 56, slot 518, face 522, and rib 524 is magnetic, while an engaging member is magnetically attractive so that receiver 520 is magnetically connected to second frame mount 500.

Effector receiver 520 includes a flat lower receiver plate 526 with a beveled central through-opening 528 and a generally arcuate upper receiver 530. Both central through-opening 528 and upper receiver 530 are sized to accommodate the dimensions of paint can 70 so that paint can 70 can be inserted into receiver 520 and frictionally secured to receiver 520 so that can 70 does not fall out of receiver 520.

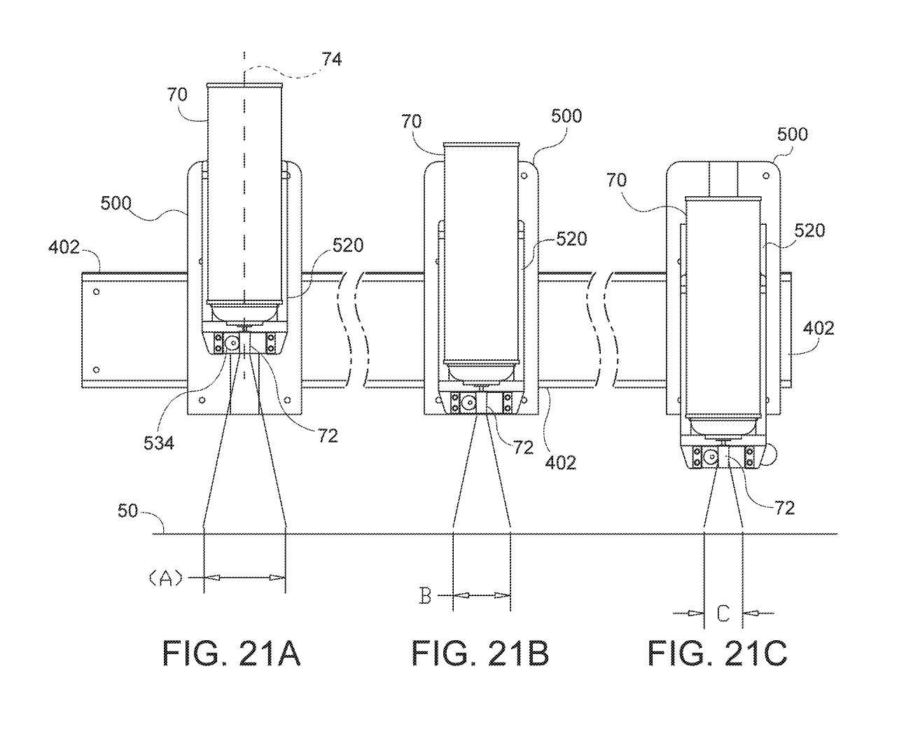

Referring to FIGS. 20 and 21A-21C, a paint discharge assembly 531 is attached to a bottom of effector receiver 520. Paint discharge assembly 531 includes an electric motor 532 having a cam 534 connected to its output. Motor 532 receives electrical power from power supply 422 through controller 404. When controlled by controller 404, motor 532 operates to rotate cam 534 sufficiently to bias a nozzle 72 on can 70 away from a longitudinal axis 74 of can 70, opening nozzle 72 and allowing paint inside can 70 to be discharged onto substrate 50.

As shown in a comparison of FIGS. 21A-C, different height locations of effector receiver 520 relative to second frame mount 500 (provided by the magnetic connection between effector receiver 520 and second frame mount 500 discussed above) result in paint spray cones of different sizes, allowing a user to adjust the thickness of lines generated by device 400. FIG. 21A shows effector receiver 520 mounted relatively high on second frame mount 500, resulting in a line thickness “A”; FIG. 21B shows effector receiver 520 mounted approximately mid-range on second frame mount 500, resulting in a thinner line thickness “B”; and FIG. 21C shows effector receiver 520 mounted relatively low on second frame mount 500, resulting in an even thinner line thickness “C”.

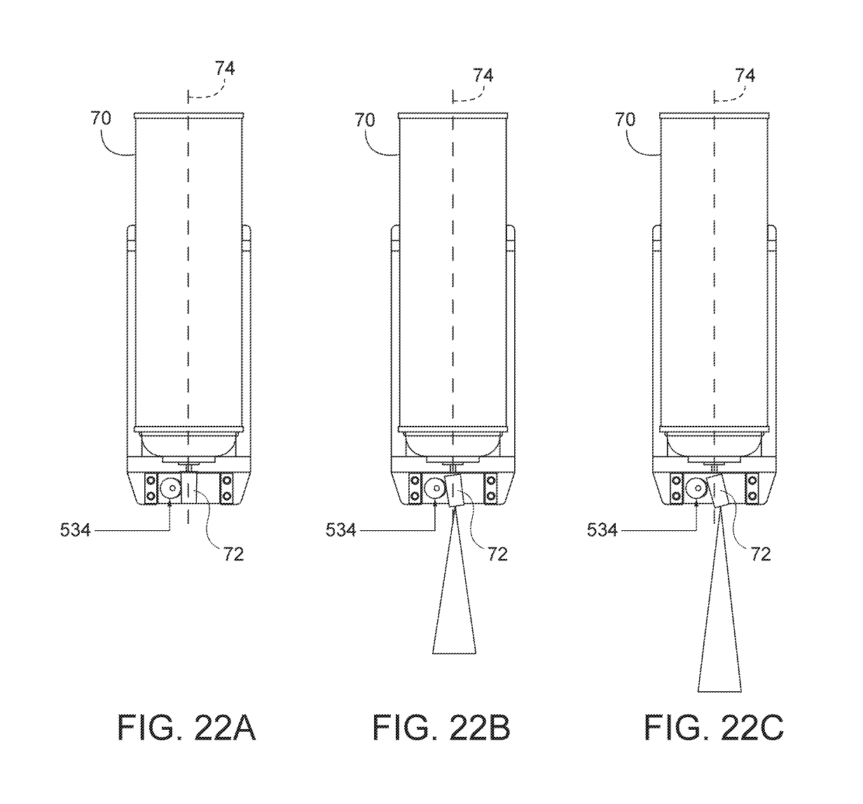

FIGS. 22A-22C show a technique for adjusting a volume of print medium dispensed from paint can 70. FIG. 22A shows cam 534 in an “OFF” position such that nozzle 72 is not activated and no paint is being discharged from can 70. FIG. 22B shows cam 534 having been rotated by motor 532 about 22½ degrees, generating a relatively small volume of paint being discharged from nozzle 72. FIG. 22C shows cam 534 having been rotated by motor 532 about 45 degrees, generating a relatively larger volume of paint being discharged from nozzle 72. Those skilled in the art will recognize that cam 534 can be rotated between about zero degrees and about 180 degrees to generate different thicknesses of lines, as desired.

Therefore, by adjusting both the height of paint can 70 relative to frame 402 and the volume of paint dispensed from paint can 70, a user can vary both line thickness and volume or density of paint to be applied to substrate 50.

To operate device 400, an electronic data file of a drawing or figure is transmitted from a remote device 60 (shown in FIG. 11) to controller 404, either wirelessly (such as by Bluetooth®) or by connecting to hardwire connection 408.

Controller 404 transmits electrical signals to motors 432 on each of first and second drive assemblies 410, 420 to drive device 400 along the “X” direction (identified in FIG. 16) on top of substrate 50. First and second drive assemblies 410, 420, although separate from each other, are operated in tandem to maintain the “X” direction.

Controller 404 also transmits electrical signals to effector motor 484 to rotate wheels 486, 488 on output wheel assembly 484 to traverse effector assembly 480 along beam 402 along the “Y” direction (identified in FIG. 16), generally orthogonal to the “X” direction. Further, controller 404 also transmits electrical signals to electric motor 532 to rotate cam 534 to move nozzle 72 for dispensing paint from can 70, drawing the figure onto substrate 50.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A printer device for riding on a substrate and depositing a print medium on the substrate, the device comprising:
a frame;
a propulsion drive connected to the frame, the propulsion drive adapted to propel the frame on the substrate in a first direction;
a power source operatively coupled to the propulsion drive;
a controller electrically coupled to the power source;
an effector assembly mounted on the frame and having an effector drive motor electrically connected to the controller to move the effector assembly in a second direction, generally orthogonal to the first direction;
an effector motor mounted on the effector assembly, the effector motor electrically connected to the controller; and
a cam mounted on the effector motor, the cam being rotatable to discharge the print medium onto the substrate from a print supply mounted on the effector assembly as the propulsion drive rides on the substrate.

2. The printer device according to claim 1, wherein the effector assembly comprises a receiver adapted to receive and retain the paint supply.

3. The printer device according to claim 2, wherein the receiver is vertically adjustable with respect to the frame.

4. The printer device according to claim 3, wherein vertical adjustment of the receiver with respect to the frame adjusts a thickness of the print medium on the substrate.

5. The printer device according to claim 4, wherein the receiver is magnetically attached to the frame.

6. The printer device according to claim 1, wherein the frame comprises a first end and a second end, and wherein the propulsion drive comprises a first drive assembly at the first end and a second drive assembly at the second end.

7. The printer device according to claim 6, wherein the power source is removably mounted on the first drive assembly.

8. The printer device according to claim 1, wherein the effector assembly rolls on the frame.

9. The printer device according to claim 1, further comprising the print supply, the print supply being a spray can with a discharge nozzle.

10. The printer device according to claim 9, wherein the controller is adapted to receive an electronic file containing a figure and wherein the controller transmits electrical signals to the propulsion drive, the effector drive motor, and the effector motor to dispense the print medium from the print supply to draw the figure on the substrate.

11. The printer device according to claim 9, wherein the cam is rotatable to a first position to move the discharge nozzle to a first position and wherein the cam is rotatable to a second position to move the discharge nozzle to a second position.

12. The printer device according to claim 11, wherein, when the nozzle is in the first position, the paint can sprays the print medium having a first thickness and wherein, when the nozzle is in the second position, the paint can sprays the print medium having a second thickness.

13. The printer device according to claim 1, wherein the frame comprises a beam and wherein the controller is located in the beam.

14. The printer device according to claim 1, wherein the frame comprises at least one toothed track and wherein the effector assembly comprises at least one toothed wheel adapted to engage the at least one toothed track.

15. A printer device for riding on a substrate and depositing a print medium on the substrate, the device comprising:
a frame having a first end and a second end;
a controller disposed in the frame;
a power supply electrically connected to the controller;
a first drive assembly connected to the first end of the frame and a second drive assembly connected to the second end of the frame, each of the first drive assembly and the second drive assembly being electrically connected to the controller such that the first drive assembly and the second drive assembly propel the frame in a first direction on the substrate;
an effector assembly mounted on the frame, the effector assembly having an effector drive motor electrically connected to the controller such that the effector drive motor translates the effector assembly in a second direction, generally orthogonally to the first direction;
a print medium supply releasably attached to the effector assembly, the print medium supply containing the print medium;
a discharge motor mounted on the effector assembly and electrically connected to the controller; and
a cam connected to the discharge motor, the cam being operable between a first position wherein the print medium is not deposited from the print medium supply on the substrate and a second position wherein the print medium is deposited from the print medium supply on the substrate.

16. The printer device according to claim 15, wherein the print medium supply is vertically adjustable relative to the frame.

17. The printer device according to claim 15, wherein a position of the cam relative to the print medium supply determines a quantity of the print medium dispensed from the print medium supply.

18. The printer device according to claim 15, wherein the effector assembly comprises:
a frame mount translatable along the frame; and
a print medium receiver releasably attached to the frame mount.

19. The printer device according to claim 15, wherein each of the first drive assembly and the second drive assembly comprises at least one wheel adapted to contact the substrate.

20. The printer device according to claim 15, wherein the controller is adapted to receive an electronic file containing a figure and wherein the controller transmits electrical signals to the first and second drive assemblies, the effector drive motor, and the discharge motor to dispense the print medium from the print medium supply to draw the figure on the substrate.
